(19) United States
(12) Patent Application Publication
(10) Pub. No.: US 2017/0193576 A1
(43) Pub. Date: Jul. 6, 2017

(54) Targeted Messaging System

(71) Applicant: BOSCH AUTOMOTIVE SERVICE SOLUTIONS INC., WARREN, MI (US)

(72) Inventor: JAMES THOMAS FISH, BIRMINGHAM, MI (US)

(21) Appl. No.: 15/393,689

(22) Filed: Dec. 29, 2016

Related U.S. Application Data
(60) Provisional application No. 62/272,803, filed on Dec. 30, 2015.

(51) Int. Cl. G06Q 30/06; G07C 5/00; G07C 5/08

(52) U.S. Cl. CPC G06Q 30/0611; G06Q 30/0613; G07C 5/0808; G07C 5/008; G07C 5/0825

(57) ABSTRACT

A diagnostic tool that retrieves a set diagnostic trouble code in a vehicle and identifies the defective part based on the set diagnostic trouble code. A targeted message having the defective part information is sent to third parties for bidding. The result of the bidding may be sent to the vehicle owner's computing device. The targeted message may also include the services needed based on the set diagnostic trouble code and third parties may also bid to perform the services needed.

### CROSS-REFERENCE TO RELATED APPLICATIONS

This application claims priority to U.S. Provisional Patent Application entitled “Targeted Messaging System, ” filed Dec. 30, 2015, the disclosure of which is hereby incorporated by reference in its entirety.

### FIELD OF THE INVENTION

The present invention relates generally to targeted messaging system. More particularly, the present invention relates to a targeted messaging system in a diagnostic environment.

### BACKGROUND OF THE INVENTION

In many industries, diagnostic systems play an increasingly important role in manufacturing processes, as well as in maintenance and repair throughout the lifetime of the equipment or product. Some diagnostic systems are based on personal computer technology and feature user-friendly, menu-driven diagnostic applications. These systems assist technicians and professionals at all levels in performing system diagnostics.

With equipment and products becoming more advanced, more complex, and more expensive with the addition of electronic components, the knowledge base and financial resources required to properly use, maintain, and fix these items have grown immensely. Further, customers, such as vehicle owners are always looking for recommendations and deals for parts and services.

Accordingly, it is desirable to provide a system that includes a diagnostic tool that allows a technician to diagnose the equipment or product, such as a vehicle and then provide the customer with targeted messages for ordering replacement parts and/or services as a result of the diagnosis.

### SUMMARY OF THE INVENTION

The foregoing needs are met, to a great extent, by the present invention, wherein in one aspect of an apparatus is provided in some embodiments include a vehicle diagnostic tool that includes a processor that performs a function of the diagnostic tool, a wireless communication interface in communication with the processor and configured to communicate with a remote device, a vehicle communication protocol interface operatively coupled to the processor and configured to allow the processor to communicate with a data link connector in a vehicle under test and retrieve a set diagnostic trouble code, a global position system that determines a location of the diagnostic tool and indirectly determines a location of the vehicle, a memory in communication with the processor, the memory containing an operating system, diagnostic software, a database of fixes that includes part's information that relate to the set diagnostic trouble code, a display in communication with the processor, wherein a defective part is determined based on the set diagnostic trouble code (DTC) and a targeted message with the defective part information is sent to the remote device of a third party who bids against other third parties to provide the defective part at a first price.

In a second embodiment, a non-transitory machine-readable storage medium that includes machine-readable instructions for causing a processor of a vehicle diagnostic tool to execute the method of, retrieving, with a processor and diagnostic software, a set diagnostic trouble code in a vehicle, determining, with a processor and a part's database, a defective part of the vehicle based on the retrieved diagnostic trouble code, generating, with the processor and the part's database, a targeted message about the defective part including a picture of the defective part, part number and part type, and sending, with a wireless interface of the vehicle diagnostic tool, the targeted message to a remote device of a third party who bids against other third parties to provide the defective part at a first price.

There has thus been outlined, rather broadly, certain embodiments of the invention in order that the detailed description thereof herein may be better understood, and in order for the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a diagnostic tool connected to a vehicle's data link connector according to an embodiment of the invention.

FIG. 2 illustrates a front view of the diagnostic tool of FIG. 1 according to an exemplary embodiment of the present invention.

FIG. 3 is a block diagram of the components of the diagnostic tool of FIG. 2 according to an embodiment of the invention.

FIG. 4 illustrates an exemplary graphical user interface (GUI) with a targeted message according to an embodiment of the invention.

FIG. 5 illustrates exemplary components of network system according to an embodiment of the invention.

FIG. 6 illustrates the targeted message on various computing devices according to an embodiment of the invention.

### DETAILED DESCRIPTION

The invention will now be described with reference to the drawing figures, in which like reference numerals refer to like parts throughout. An embodiment in accordance with the present invention provides a computing device, such as a diagnostic tool, notebook, tablet, smart phone, smart glasses, smart watch and the like along with a server to provide the targeted message to a customer.

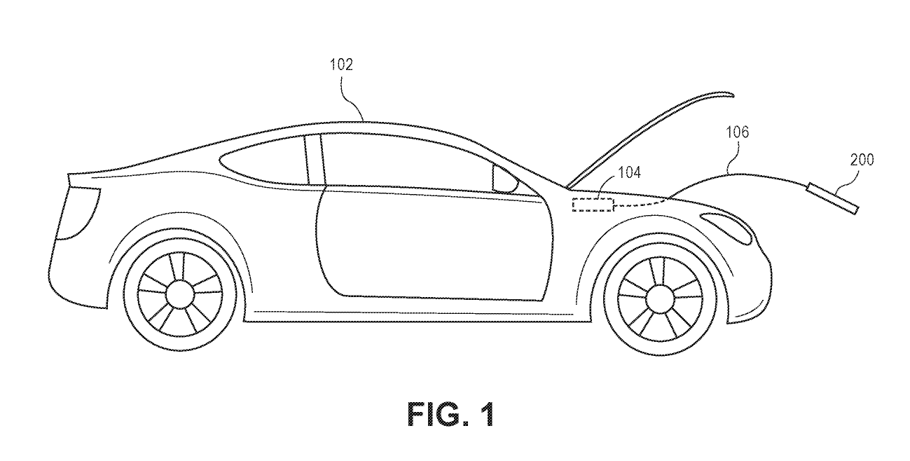

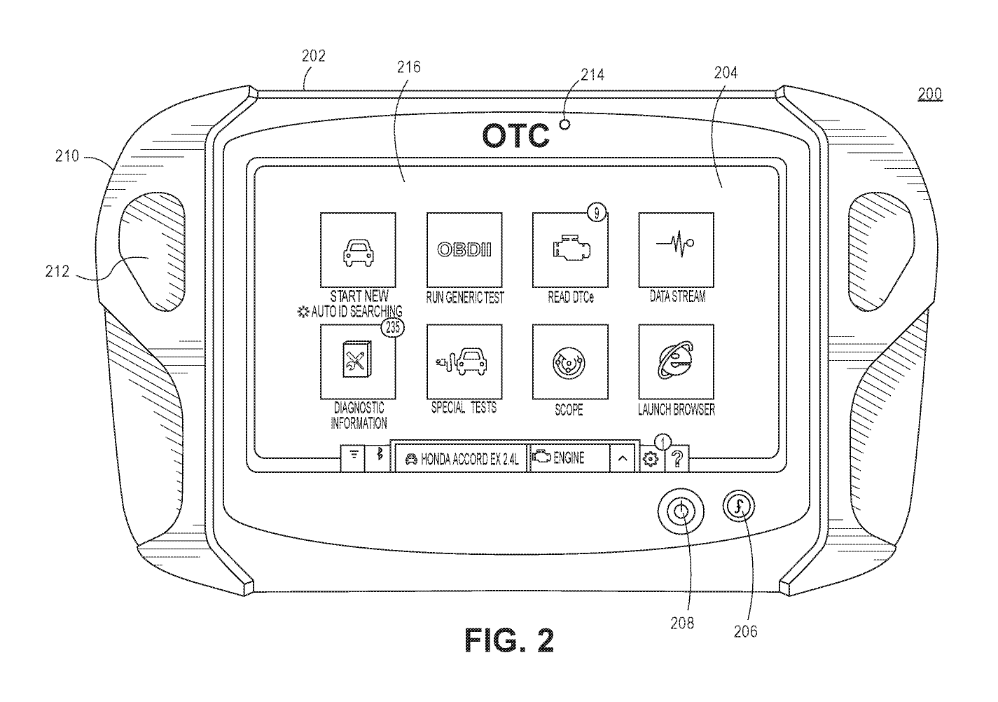

FIG. 1 illustrates a diagnostic tool 200 connected to a vehicle's data link connector 104 according to an embodiment of the invention. The diagnostic tool 200 can be any computing device. An example of the diagnostic tool is the Genisys® Touch from Bosch Automotive Service Solutions, Inc. (Warren, Mich.) as further discussed in FIG. 2. The diagnostic tool 200 connects to the data link connector 104 of a vehicle 102 via a cable 106. Once connected, the diagnostic tool can communicate with the vehicle's various electronic control units (ECUs) in order to diagnose the vehicle. For example, diagnostic trouble codes can be stored in various ECUs' memories and retrieved using various communication protocols available on the diagnostic tool 200. In an alternative embodiment, the diagnostic tool 200 may communicate with the data link connector via a wireless connection.

FIG. 2 illustrates a front view of the diagnostic tool 200 of FIG. 1 according to an exemplary embodiment of the present invention. The diagnostic tool 200 may include a housing 202, a display 204 with graphical user interface (GUI) 216, a user interface 206, a power button 208, gripping portions 210 having a finger (thumb) receiving portion 212, and a camera 214. The power button 208 can also be used to put the diagnostic tool 200 into a standby mode in order to save battery power when not in use.

The gripping portions 210 may be made of a polymer including hydrogels for easy gripping. The finger receiving portion 212 may be configured to receive a finger, such as a thumb of the user, to assist in better gripping of the diagnostic tool 200. The user interface 206 can be a function button and may be configured for any function desired by the user including enter, back, forward, left, right, up, down, transmit, receive, return, start over, and the like. The user interface 206 in the form of the function button can also include multiple functions of any combination of functions, such as enter and then back, etc. The user interface 206 may also include a keyboard having numbers and letters and/or be alphanumeric and the like.

The display 204 can be any type of display including a touch screen display, LCD, LED, VGA, OLED, SVGA, and other types of displays. The display 204 may be a colored, non-colored (e.g. gray scale), or a combination of both. The display 204 can display information such as the make, model, year of vehicle that the diagnostic tool 200 can diagnose, the various diagnostic tests the diagnostic tool can run, diagnostic data the diagnostic tool has received, the baseline data of the various components in a vehicle, part images, parts information, and information from remote servers (internet, database information, etc.). Additionally, the display can show videos for the user to view, and the accompanying audio can be heard via the built in speakers (not shown). The speakers can be a single speaker or multiple speakers for stereo sound. A microphone (not shown) may be included and allows the technician to record information such as the noise being made by the vehicle for later analysis or for comparison with stored data. Further, the technician can also record comments or notes during the testing for later retrieval and analysis.

In one embodiment, the display allows the user to input selection through the touch screen for interactive navigation and selection, wherein the technician can select a menu item or icons (further discussed below) by touching the selection on the graphical user interface (GUI) 216. Additionally, the display 204, when tapped or touched, can also be used to wake up the diagnostic tool 200 if it is in a sleep mode.

The camera 214 may be positioned to face the user so that the user may conduct a video chat with another person at a remote location. The camera may also be positioned on any surface of the diagnostic tool 200 including on the opposite side of display 204 so that images of parts of an engine or any components desired by the user can be taken.

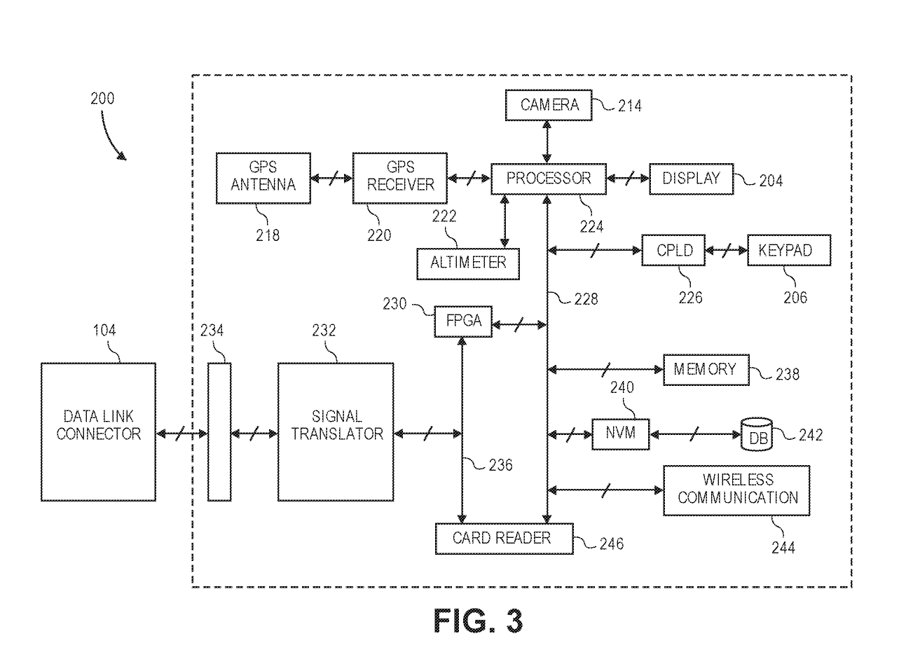

FIG. 3 is a block diagram of the components of the diagnostic tool 200 of FIG. 2 according to an embodiment of the invention. In FIG. 3, the diagnostic tool 100 may include a camera 214, a processor 224, a field programmable gate array (FPGA) 230, a first system bus 236, the display 204, a complex programmable logic device (CPLD) 226, the input device 206 or function button, a memory 238, an internal non-volatile memory (NVM) 240 having a database 242 with software program, a card reader 246, a second system bus 228, a connector interface 234, a selectable signal translator 232, a GPS antenna 218, a GPS receiver 220, an altimeter 222, and a wireless communication circuit 244.

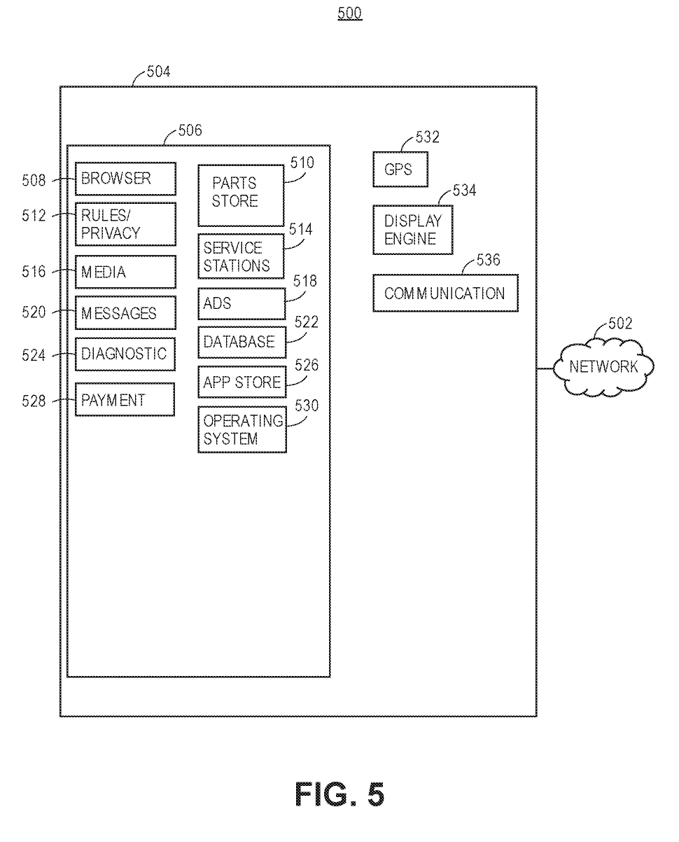

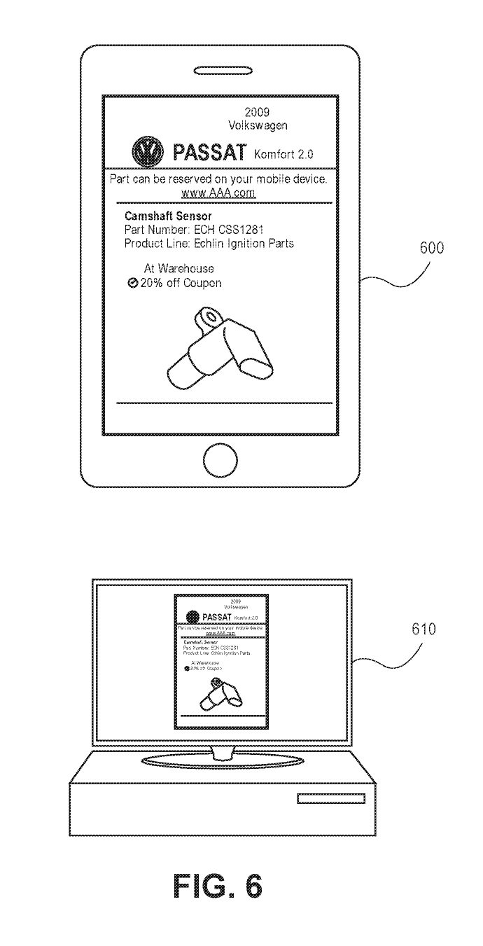

The wireless communication circuit 244 can be configured to communicate wirelessly with other computing devices such as a smart phone 600 (FIG. 6) of a consumer, a server 504 (FIG. 5), a personal computer 610 (FIG. 6) or another remote device and the like. The wireless communication circuit 244 communicates with the processor 224 via the second system bus 228. The wireless communication circuit 224 can be configured to communicate via RF (radio frequency), satellites, cellular phones (analog or digital), Bluetooth®, Wi-Fi, Infrared, ZigBee, Local Area Networks (LAN), WLAN (Wireless Local Area Network), NFC (near field communication), other wireless communication configurations and standards, or a combination thereof. The wireless communication circuit 224 allows the diagnostic tool 200 to communicate with other devices wirelessly such as with the server 504 having remote databases. The wireless communication circuit 224 includes an antenna or transceiver built therein (not shown) and being housed within the housing 202 or can be externally located on the housing 202.

Signal translator 232 conditions signals received from an ECU unit via the data link connector 104 coupled to the connector interface 234 to a conditioned signal compatible with diagnostic tool 200 and vice versa. Signal translator 232 can communicate with, for example, the following communication protocols: J1850 (VPM and PWM), ISO 9141-2 signal, communication collision detection (CCD) (e.g., Chrysler collision detection), data communication links (DCL), serial communication interface (SCI), Controller Area Network (CAN), Keyword 2000 (ISO 14230-4), OBD II or other communication protocols that are implemented in a vehicle.

The circuitry to translate and send in a particular communication protocol can be selected by FPGA 230 (e.g., by tri-stating unused transceivers). Signal translator 232 may be also coupled to FPGA 230 and the card reader 246 via the first system bus 236. FPGA 230 transmits to and receives signals (i.e., messages) from the ECU unit through signal translator 232.

The FPGA 230 may be coupled to the processor 224 through various address, data and control lines by the second system bus 228. FPGA 230 is also coupled to the card reader 246 through the first system bus 236. The processor 224 may also be coupled to the display 204 in order to output the desired information to the user. The processor 224 communicates with the CPLD 226 through the second system bus 228. Additionally, the processor 224 may be programmed to receive input from the user through the input device 206 via the CPLD 226 or via the touchscreen display 204. The CPLD 226 may provide logic for decoding various inputs from the user of the diagnostic tool 200 and also provides glue-logic for various other interfacing tasks.

Memory 238 and internal non-volatile memory 240 may be coupled to the second system bus 228, which allows for communication with the processor 224 and FPGA 230. Memory 238 can include an application dependent amount of dynamic random access memory (DRAM), a hard drive, flash memory and/or read only memory (ROM). Software to run the diagnostic tool 200 including the GUI and to provide targeted messaging can be stored in the memory 238 or 240, including any other database. The database 242 can include diagnostic information, diagnostic tests, diagnostic software, schematics, maps, instructions, parts information, and other information related to vehicles.

Internal non-volatile memory 240 can be an electrically erasable programmable read-only memory (EEPROM), flash ROM, or other similar memory. Internal non-volatile memory 240 can provide, for example, storage for boot code, self-diagnostics, various drivers, and space for FPGA images, if desired. Additionally, the internal non-volatile memory 240 may also include software such as a graphics module for rendering and displaying graphics (e.g. icons or modules) on the touchscreen display 204. If less than all of the modules are implemented in FPGA 230, memory 240 can contain downloadable images so that FPGA 230 can be reconfigured for a different group of communication protocols.

A GPS antenna 218 and GPS receiver 220 can be included and may be mounted in or on the housing 202 or any combination thereof. The GPS antenna 218 electronically couples to the GPS receiver 220 and allows the GPS receiver to communicate (detects and decodes signals) with various satellites that orbit the Earth. In one embodiment, the GPS antenna 218 and GPS receiver 220 are one device instead of two. The GPS receiver 220 and GPS antenna 218 may electronically couple to the processor 224, which may be coupled to memory 238, 240 or a memory card in the card reader 246. The memories can be used to store cartographic data, such as electronic maps. The diagnostic tool 200 can include all the maps for the U.S. (or country of use), North America, or can have the region or state where the diagnostic tool is located. In alternative embodiments, the diagnostic tool can have all the maps of the world or any portion of the world desired by the user. This allows the diagnostic tool to be a GPS device so that a driver can drive from one location to another or indirectly provide the location of the vehicle. The maps may be overlay or may incorporate traffic, local events, and location of other GPS devices (smart phones), and other information that can be useful to the technician.

The GPS receiver communicates with and “locks on” to a certain number of satellites in order to have a “fix” on its global location. Once the location is fixed, the GPS receiver, with the help of the processor, can determine the exact location including longitude, latitude, altitude, velocity of movement, and other navigational data of the diagnostic tool 200.

Should the GPS receiver be unable to lock onto the minimum number of satellites to determine the altitude or unable to determine the altitude for any reason, the altimeter 222 can be used to determine the altitude of the diagnostic tool 200. The altimeter 222 is electronically coupled to the processor 224 and can provide the altitude or elevation of the diagnostic tool 200. The altimeter 222 can be coupled to a barometric pressure sensor (not shown) in order to calibrate the elevation measurements determined by the altimeter. The sensor can be positioned interior or exterior to the housing 202 of the diagnostic tool 200. Minor atmospheric pressure changes can affect the accuracy of the altimeter 222, thus, diagnostic tool can correct for these changes by using the sensor in conjunction with the altimeter 222 along with a correction factor known in the art.

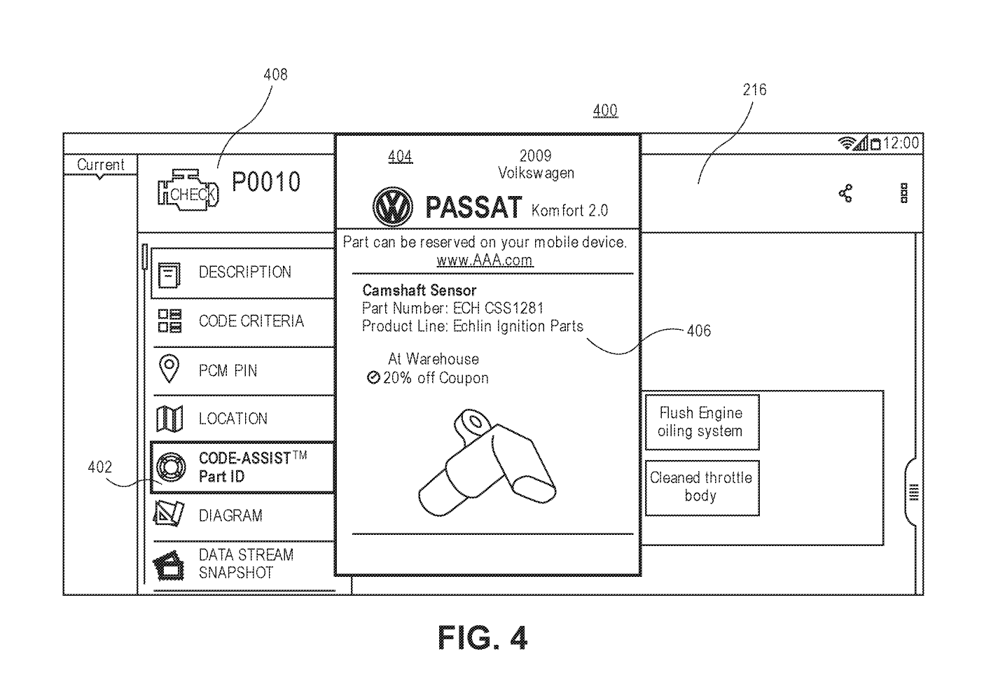

FIG. 4 illustrates an exemplary graphical user interface (GUI) 216 with a targeted message 404 according to an embodiment of the invention. The GUI 216 may include various icons, information banner, modules, interface elements, and the like. The icons or modules may be activated by touching with a finger or a stylus and the like on the display 204 or through the user interface 206. The display 204 can be touch sensitive and is able to interpret finger contacts, finger tap gestures, finger swipe gestures, stylus movements, any combination thereof, and the like. It should be understood that, in some embodiments, one or more of the finger inputs are replaced with input from another input device (e.g., a mouse based input or stylus input). For example, a swipe gesture may be replaced with a mouse click (e.g., instead of a contact) followed by movement of the cursor along the path of the swipe (e.g., instead of movement of the contact). A further embodiment, a tap gesture may be replaced with a mouse click while the cursor is located over the location of the tap gesture (e.g., instead of detection of the contact followed by ceasing to detect the contact). Similarly, when multiple user inputs are simultaneously detected, it should be understood that multiple computer mice may be used simultaneously, or a mouse and finger contacts may be used simultaneously.

As discussed above, once the diagnostic tool 200 is connected to the data link connector 104, vehicle diagnostic may be performed on the vehicle 102. For example, diagnostic trouble code 408 may be pulled among other diagnostic trouble codes (DTCs) that are stored in the various ECUs of the vehicle. Once the DTC 408 is pulled, various databases such as iATN™, Code-Assist™, Google™, Direct-Hit™, and Symptom-Assist™, are available that relates to that particular DTC 408 or issue stored on the diagnostic tool 200 or on a remote server 504 may be used to diagnose the vehicle and determine how to service the vehicles including the parts needed. Each DTC has corresponding parts that when broken or becomes defective could cause the DTC to be set in the ECU. In alternative embodiment, the scan is conducted automatically when the diagnostic tool 200 is coupled to a data link connector 104 in a vehicle. The data link connector (not shown) provides access to various ECUs (electronic control unit) in the vehicle.

Once the DTCs are pulled (via the processor and diagnostic software), the user of the diagnostic tool 200 may select the Code-Assist™, icon 402 in order to determine what part and/or services are needed based on the determined diagnose or the set DTC. Once the defective part including part number is identified and/or services that are needed, a targeted message 404 as shown in FIG. 4 can be generated and sent to the consumer or to third parties for auction or bidding. The targeted message 404 may be generated on the diagnostic tool 200 and/or the server 504 and sent to a remote computing device. The remote computer may be a smart phone or computing device of the consumer (based on the cell number given, email, social media accounts, etc.), third parties (parts store, auction house, etc.)

If the targeted message 404 is generated on the diagnostic tool 200, it can be shown on GUI 216, which also includes various icons, information banner and the like. The targeted message 404 may include various information including the current vehicle under test, such as a 2009 Volkswagen Passat or any other vehicle, part information including the part number, diagram or picture of the part, part manufacturer, where the part was manufactured and/or assembled, part type, part description and the like, where to purchase the part, where to have the part installed, if needed, tools that will be needed to install the parts, and the like. Alternatively or in addition to, the targeted message may include identified services for the vehicle based on the set DTC that may also be put out to bid or auctioned similar to the needed parts. However unlike typical auctions, the price being bid by third parties parts stores and/or service stations will generally start at one price point and go lower instead of higher. For example, if the diagnostic determines that the vehicle needs alternator replacement, then various service stations can bid to provide such services and the price for the service. Additionally, the next appointment and/or time to completion can also be factors in the bidding for the consumer to consider. The auction/bidding solves the problem of continuing to search for the best price and allows a dynamic change in pricing until the consumer is satisfied. The auction including the results of the auction is relayed to the consumer's computing device.

In one embodiment, the location of the diagnostic tool 200 via the GPS receiver 220 can be used to determine the closest part store and/or service location. The location may also be based on location of the Wi-Fi connection or cellular connection to which the diagnostic tool 200 is connected. In another embodiment, the required part information may be sent to third parties for bidding purposes. Thus, companies like Advanced Auto Parts, Autozone, NAPA, Pep Boys, O'Reilly, AAA Auto Centers, junk yards, service stations, and the like can bid on the price for the part and/or services. Additionally, even individuals who may have the part (used or new) can also participate in the auction or bidding.

The bidding may include location of the part, part availability, shipping options, price, coupons, specials and the like. The bidding can be timed so that the bidding is completed within the consumer's desired time frame or it can be instantaneous, online bidding where other bidders can see the current bid price and then they can decrease their price or add other discounts or incentives. In another embodiment, the consumer can participate in the bidding by setting a price that he is willing to pay for the part and/or service. By allowing third parties to bid for the part and/or services, this allows for the consumer make an informed decision as to where to receive the best price and/or convenient location for the part and/or service.

FIG. 5 illustrates exemplary components of network system 500 according to an embodiment of the invention. The network system 500 includes the network 502 and the server 504. In the event that the targeted message is generated on the server 504, then the retrieved DTC of the vehicle is transmitted to the server via the network 502. The network system 500 may be located anywhere including locally (e.g. service station), at any third party such as web hosting site (e.g. Microsoft, Amazon Web Service), a parts store, an auction house and the like. Further, the functions of the server may be performed on any computing device. Major hardware components of the server such as processor, power source, interfaces (input/output), other memories and components that are part of the server 504 are not shown but are known in the art. Network 502 may be any type of network such as Wi-Fi, LAN (local area network), WAN (wide area network), cellular, satellite, zigbee, SAN (storage area network), PAN, (personal area network), MAN (metropolitan area network), Internet or a distributed network and the like.

Memory 506 may store various information, formulas, images, objects, data, applications, software, maps, diagrams, and the like. The applications that may be stored in the memory 506 include Browser Manager 508, Parts Store (third parties) Manager 510, Rules/Privacy Manager 512, Transit Service Stations Manager 514, Media/Content Manager 516, Ads Generator 518, Messages Manager 520, Database 522, Diagnostic Manager 524, App Store 526, and Payment Manager 528. Other applications may also be stored to practice the embodiments of the invention. These applications/managers may interact with each other in order to function properly or for their configured purpose. An operating system 530 is also stored in memory 506.

Further, these applications can also interact with a connected vehicle (vehicles connected wirelessly), a wireless device (e.g. smart phone, smart watch, smart glasses) or computing devices (e.g. tablet, laptop, personal computer) of third parties or the consumers and the like. Browser Manager 508 interacts with the browsers used by computing devices such as wireless devices, connected vehicles, or other computing devices that include Apple Safari, Microsoft Explorer or Edge, Google Chrome and the like and also interacts with the various applications discussed herein. The Browser Manager 508 allows the server (third parties, service stations, action house, parts store, etc.) owner to perform operations such as controlling the browser content including posting, message alerts, targeted messaging, multimedia content and the like. The Browser Manager 508 may interact with the Diagnostic Manager 524 in order to provide the user or subscriber with the desired experience.

Parts Store Manager 510 manages the interactions with the various part stores including the third parties that will participate in the auction and can provide the parts and/or services. The Parts Store Manager stores or keeps track of the physical addresses, and virtual addresses such as emails, phone numbers and the like. Further, Parts Store Manager 510 can also manage the auction for the part and/or services desired by the consumer. The Parts Store Manager can also query the various parts store for pricing and availability of the parts.

Rules/Privacy Manager 512 may control the various rules settings of the web site (or the owner of the website) including controlling different privacy levels set by the user or settings imposed by the website's owner. Service Station Manager 514 can manage information about the various service stations that want to participate in the auction and manage their contact information such as addresses, emails, phone numbers, webpages, other social media sites, and the like. Further, the Service Station Manager 514 can communicate with the various service stations to obtain services available and pricing.

Media Manager 516 can control the multimedia information (how the part functions, how to install the part, etc.) that may be uploaded or downloaded to the consumer. Multimedia information may include links, news, video files, photographs, audio files (music, sound, etc.) and the like. Ads Generator 518 may control the various ads that may be present on the website or in the targeted message including their placement in terms of position and timing. For example, Ads Generator 518 may push ads related to the needed parts and/or services and any specials or discounts related to the parts and/or services. Messages Manager 520 may also control the various targeted messages and messages that are being posted and responded on the website by the various users. Messages Manager 520 may also be a “messenger” system that is separate from the website so that consumers, technicians or other third parties may communicate with each other. By having the “messenger” system separate from the website, this helps to control amount of information that is being processed by the website at any given time and may allow for faster real-time messaging to occur.

Database 522 can be used to store various information and data including pictures, images, software, maps, media files (video and audio), subscriber/consumer/third parties information, diagnostic information, posting information, messaging information, parts information, parts store and/or service station information, rules information, setting information, ads information, application information, browser information, location information, payment information, and the like. Database 522 may also be accessed via the network 502 by the wireless devices, the connected vehicles or other external computing devices (service stations, parts store, third parties, etc.). Database 522 can also access other remote databases via the network 502.

Diagnostic Manager 524 can receive and analyze various diagnostic information such as diagnostic trouble codes (DTCs), other vehicle diagnostics of the consumer's vehicle. Diagnostic manager 326 can also interact with consumer wireless devices or other third parties computing device in order to solicit bids or hold the auction for the needed parts and/or services by sending the targeted message.

App Store 526 can control various apps that can be downloaded to devices such as the wireless devices or other computing devices. Examples of the App Store 526 include Google Play and Apple App Store and the like. Payment Manager 528 allows the consumer or user to pay for parts and/or services utilized either by entering their own credit card, debit card, gift card and discount codes or interacting with other pay services such as PayPal, Apple pay, Google pay and the like. The Payment Manager can store credit card, debit card, gift card, discount codes, contact information (addresses, phone numbers, emails, etc.) and the like. Operating system 530 stored in the memory can include Apple iOS, Google Android, Windows 10, Linux and the like. It should be noted that although these managers/apps are discussed individually, one or more functionality may be combined into one app instead of being separated.

Other components for server 504 can include GPS System 532, display engine 534, and communication interface 536. GPS system 340 can track the various locations of the consumer, vehicles, computing devices, diagnostic tools, wireless devices, subscribers, parts store, service station and the like and provide their respective locations in relation to each other. Thus, the consumer will know where the nearest parts store and/or service station are located. Display engine or graphical user interface (GUI) generator 534 can control display of information on the display of the wireless devices or the displays of various connected computing devices. For example, GUI generator 534 can control various parts of the browser or targeted messages to show a map of the nearest parts store and/or service stations, information about the parts and/or services, diagrams or pictures of the parts, pricing information and the like. Further, GUI generator 534 can also interpret the interactions by the user of the wireless devices or of connected computing devices so that requested information or received information is properly processed. Communication interface 536 allows for wired or wireless communication between the server and its components and the network 502. Wired connection may be USB, FireWire, serial, parallel and the like. Wireless communication may include Wi-Fi, Bluetooth, Zigbee, near field communications, radiofrequency, satellite, cellular and the like. FIG. 6 illustrates the targeted message 404 on various computing devices according to an embodiment of the invention. For example, the targeted message 304 may be displayed on the consumer's wireless device 600 or on a third party's computing device 610.

It should also be noted that the software implementations of the invention as described herein can be stored on a tangible, non-transitory storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. Accordingly, the invention is considered to include a tangible storage medium or distribution medium, as listed herein and including art-recognized equivalents and successor media, in which the software implementations comprising code segments are stored. Additionally, although a diagnostic tool is described herein, the invention may be implemented on any computing device such as a personal computer, notebook, smart phone, a tablet and the like.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A vehicle diagnostic tool, comprising:
a processor that performs a function of the diagnostic tool;
a wireless communication interface in communication with the processor and configured to communicate with a remote device;
a vehicle communication protocol interface operatively coupled to the processor and configured to allow the processor to communicate with a data link connector in a vehicle under test and retrieve a set diagnostic trouble code;
a global position system that determines a location of the diagnostic tool and indirectly determines a location of the vehicle;
a memory in communication with the processor, the memory containing an operating system, diagnostic software, a database of fixes that includes part's information that relate to the set diagnostic trouble code; and
a display in communication with the processor, wherein a defective part is determined based on the set diagnostic trouble code (DTC) and a targeted message with the defective part information is sent to the remote device of a third party who bids against other third parties to provide the defective part at a first price.

2. The diagnostic tool of claim 1, wherein other third parties offer a second price, which is lower than the first price.

3. The diagnostic tool of claim 1, wherein the targeted message is sent to the vehicle owner's computing device.

4. The diagnostic tool of claim 1, wherein the defective part information include part number, part type and any specials available for the defective part.

5. The diagnostic tool of claim 1, wherein the targeted message also includes identified service needed for the vehicle based on the set DTC.

6. The diagnostic tool of claim 5, wherein the targeted message is also sent to the third party who bids against other third parties to provide the identified service at second price.

7. The diagnostic tool of claim 6, wherein other third parties offer a third price, which is lower than the second price.

8. The diagnostic tool of claim 5, wherein the defective part information include the make and model of the vehicle.

9. The diagnostic tool of claim 1, wherein the targeted message include the location of the vehicle.

10. The diagnostic tool of claim 2, wherein the results of the bidding are sent to the vehicle owner's computing device.

11. A non-transitory machine-readable storage medium comprising machine-readable instructions for causing a processor of a vehicle diagnostic tool to execute the method of:
retrieving, with a processor and diagnostic software, a set diagnostic trouble code in a vehicle;
determining, with a processor and a part's database, a defective part of the vehicle based on the retrieved diagnostic trouble code;
generating, with the processor and the part's database, a targeted message about the defective part including a picture of the defective part, part number and part type; and
sending, with a wireless interface of the vehicle diagnostic tool, the targeted message to a remote device of a third party who bids against other third parties to provide the defective part at a first price.

12. The non-transitory machine-readable storage medium of claim 11, wherein the other third parties offer the defective part at a second price, which is lower than the first price.

13. The non-transitory machine-readable storage medium of claim 11 further comprising:
sending, with the wireless interface of the vehicle diagnostic tool, the targeted message to the vehicle owner's computing device.

14. The non-transitory machine-readable storage medium of claim 11 further comprising:
determining, with the processor and diagnostic software, a service needed by the vehicle based on the retrieved diagnostic trouble code; and
sending the service needed in the targeted message to the third party who bids against other third parties to provide the service needed at a second price.

15. The non-transitory machine-readable storage medium of claim 14, wherein the other third parties offer the service needed at a third price that is lower than the second price.

16. The non-transitory machine-readable storage medium of claim 11, wherein the defective part information include part number, part type and any specials available for the defective part.

17. The non-transitory machine-readable storage medium of claim 11, wherein the defective part information include the make and model of the vehicle.

18. The non-transitory machine-readable storage medium of claim 11, wherein the targeted message include the location of the vehicle.

19. The non-transitory machine-readable storage medium of claim 11, wherein the results of the bidding are sent to the vehicle owner's computing device.

20. The non-transitory machine-readable storage medium of claim 15, wherein the results of the bidding are sent to the vehicle owner's computing device.
